(19) United States
(12) Patent Application Publication
(10) Pub. No.: US 2003/0164874 A1
(43) Pub. Date: Sep. 4, 2003

(54) Pan head having compact oscillating mechanism and optical apparatus using the same

(75) Inventor: Toru Sawada, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/377,368

(22) Filed: Feb. 27, 2003

(30) Foreign Application Priority Data
Mar. 1, 2002 (JP) 2002-056537

(51) Int. Cl. H04N 7/00

(52) U.S. Cl. 348/36; 348/39

(57) ABSTRACT

A pan head includes a swinging member capable of swinging about a swing axis; a first moving member mounted on the swinging member and capable of slidingly moving along the swing axis; and a seat capable of turning about an axis perpendicular to the swing axis, as a turning axis. Herein, the sliding movement of the first moving member is converted into a turning movement of the seat. The swinging member and first moving member are each driven by a voice coil motor (VCM).

### BACKGROUND OF THE INVENTION

1. Field of the Invention

The present invention relates to a pan head having a compact oscillating mechanism, and an optical apparatus with an optical device mounted on this pan head.

2. Description of the Related Art

Hitherto, surveillance cameras or projectors that have an oscillating mechanism capable of swinging in both of the horizontal and vertical axis directions, have been used in many fields In general, the oscillating mechanism is constituted by combining a horizontal rotational movement about a vertical axis as a rotational axis and a vertical rotational movement about a horizontal axis as a rotational axis. For example, as shown in FIG. 7, a conventional camera swivel device has two DC motors 201 and 208. The DC motor 208 provides a horizontal swivel base 207 with a horizontal rotational movement using a vertical shaft 206 as a pivot, by a combination of horizontal rotating gears (not shown). On the other hand, the DC motor 201 provides a horizontal shaft 202 disposed on the horizontal swivel base 207 with a vertical rotational movement using a combination of a worm gear 204 and a vertical rotating gear 205. The horizontal shaft 202 is connected to a camera fixing base 203, and a surveillance camera (not shown) is mounted on this camera fixing base 203. When the DC motor 208 is driven, the camera swivel device swings the camera in the horizontal direction according to the rotational direction and rotational amount of the motor shaft. On the other hand, when the DC motor 201 is driven, the camera swivel device swings the camera in the direction of elevation/depression angle, i.e., in the vertical direction, according to the rotational direction and rotational amount of the motor shaft. Therefore, appropriate control of the driving of each of the DC motors 201 and 208 allows the camera to be oscillated in an arbitrary direction. Also, continuous driving of the DC motors 201 and 208 according to a predetermined program enables scanning (panning).

In recent years, products in which a CCD camera or the like is installed on a compact information device, such as a portable personal computer or mobile telephone, have been developed and have begun to come into proliferation. If the camera is fixed to the information device body, the angle of view thereof will be inconveniently limited, and therefore, it has been required to provide an oscillating function to the camera within the range in which the essential demand for miniaturization of information device does not fail to be met. In this case, when the oscillation movement is manually conducted, it suffices only to mount the camera on the pivot. However, when the swing angle is to be accurately controlled, or scanning is to be automatically performed, or when the swing angle is to be changed according to a given program, there emerges a need for a compact and high-responsivity oscillating mechanism capable of being driven by electronic control from the information device body. However, the conventional oscillating mechanisms, in which the horizontal rotational movement and vertical rotational movement are combined using two DC motors as described above, have been unable to address the demand for miniaturization, thereby making difficult its adoption into a compact information device.

Also, in the field of projectors, for example, when attempting to oscillate an illuminating light at the front end of a fiberscope, because a large-sized oscillating mechanism as described above cannot be mounted on the front end, a plurality of cables has hitherto been stretched between the front end and the hand-side end of the fiberscope along the peripheral wall thereof, and the swing angle has been adjusted by subjecting these cables to drawing operation at the hand-side end. However, this method has allowed neither the accurate controlling of an swing angle, nor continuous scanning according to a program.

Moreover, also in the fields of various mechanisms other than optical apparatuses, and in the fields of toys or the like, a pan head having a compact and electronically-controllable oscillating mechanism has hitherto been strongly demanded.

### SUMMARY OF THE INVENTION

Accordingly, it is an object of the present invention to provide a pan head having a compact and electronically-controllable oscillating mechanism, and an optical apparatus using the same.

In order to solve the above-described problems, the present invention provides a pan head includes a swinging member capable of swinging about one axis as a swing axis; a first moving member supported by the swinging member, and capable of slidingly moving along the swing axis; and a seat capable of turning about an axis perpendicular to the swing axis, as a turning axis. Herein, the sliding movement of the first moving member is converted into a turning movement of the seat.

In the oscillating mechanism in the pan head of the present invention, for example, when it is assumed that the swing axis is placed in the horizontal direction, and the turning axis of the seat is placed in the vertical direction, the swinging movement of the swinging member causes the seat to oscillate in the up-down direction, while the sliding movement of the first moving member is converted into a turning movement of the seat and causes the seat to oscillate in the right-left direction. Therefore, appropriately adjusting the swing direction and swing angle of the swinging member, and the movement direction and moving amount of the first moving member, enables the seat to oscillate in an arbitrary direction. Since the pan head according to the present invention converts the swinging movement of the swinging member and the sliding movement of the first moving member along the swing axis into an oscillation movement, all operation for oscillation can be performed along a single axis, thereby making the miniaturization of the oscillating mechanism easy compared with that using two rotating axes horizontal and vertical, which are orthogonally intersect each other, as a rotational axis, as in the case of the conventional oscillating mechanisms.

It is preferable that the above-described seat have a turning member at a position a distance away from the turning axis, that the first moving member have engagement portions where the first moving member is engaged with the turning member, and that the sliding movement of the first moving member be converted into a turning movement of the seat by the engagement between the turning member and engagement portions.

Thereby, the sliding movement of the first moving member is directly converted into a turning movement of the seat.

Preferably, the first moving member slidingly moves by being driven by voice coil motors (hereinafter referred to as VCMs) each comprising a magnet mounted on either one of the first moving member and swinging member, and a coil mounted on the other.

By arranging VCMs each comprising a magnet and coil that relatively move parallel with each other between the first moving body and swinging member, it is possible to perform electromotive movement operation with respect to the first moving member, without the need for power transmission devices such as gears, unlike the case of conventional oscillating mechanisms, thereby enabling accurate, rapid, and efficient driving to be achieved.

In general, the VCM is arranged so that the magnet and coil thereof are opposed in non-contact with each other, and that the relative movement direction and moving amount between the magnet and coil can be determined in response to the direction and amount of a current flowing through the coil. Therefore, if the magnet and coil is opposed along the swing axis, and the direction and amount of a current flowing through the coil is controlled, the movement direction and moving amount of the coil with respect to the magnet could be accurately controlled. By applying this relative movement between the coil and magnet to the sliding movement of the first moving member with respect to the swinging member, the turning direction and turning angle of the seat, which is operatively connected to the first moving member, can be accurately determined. Driving the first moving member by the VCM eliminates the need to use gears or the like for the transmission of a power unlike the conventional oscillating mechanisms, so that quiet operation becomes feasible, and the driving force is smoothly converted into a turning movement of the seat, thereby enhancing the energy efficiency as well as improving the responsivity. In the conventional combination of the DC motors and gears, the accurate control of an oscillation angle and the braking of oscillation have been difficult, whereas, in the VCM, the amount of a current flowing through the coil thereof accurately corresponds to the oscillation amount, thereby improving the accuracy of oscillation control. Also, in the VCM, no non-reciprocal transmission member is employed, such as a worm gear, unlike the conventional oscillation mechanisms, and therefore, even if the oscillation position of the seat is forcedly changed by an external force, there will be no risk of the breaking of the transmission member.

It is preferable that the above-described swinging member have a second moving member mounted on the swinging member and capable of slidingly moving along the swing axis, and that the sliding movement of the second moving member be converted into an swinging movement of the swinging member.

Thereby, the operation for swinging the swinging member can be performed by the movement of the second moving member along the swinging axis. This eliminates the need to provide-a power source outside, thereby facilitating the miniaturization of the swinging member.

In the present invention, it is preferable that the above-described pan head further include a non-rotating fixed shaft extending coaxially with the swing axis, wherein the above-described second moving member is opposed to the peripheral surface of the fixed shaft; a spiral groove extending along the swing axis, the spiral groove being formed on either one of the peripheral surface of the fixed shaft and the second moving member; and a slider sliding in engagement with the spiral groove, the slider being disposed on the other of the above-described peripheral surface of the fixed shaft and the second moving member. Herein, it is preferable that, when the second moving member moves along the swing axis, the slider moves along the spiral groove, and thereby the moving motion of the second moving member is converted into an swinging movement of the swinging member.

This mechanism is suitable means for converting a moving motion of the second moving member into an swinging movement of the swinging member, and it is arranged to form a spiral groove on either one of a fixed shaft provided coaxially with the swing axis and the second moving member, and to move the other along the spiral groove to thereby convert the moving motion of the second moving member into an swinging movement of the swinging member. In this movement conversion means, all motions are performed coaxially with respect to the swing axis, it is suitable for the miniaturization of a pan head.

Preferably, the above-described second moving member slidingly moves by being driven by a voice coil motor comprising a magnet mounted on either one of the peripheral surface of the fixed shaft and the second moving member, and a coil mounted on the other.

By arranging a VCM comprising a magnet and coil that relatively move parallel with each other between the fixed shaft and the second moving body, it is possible to perform direct electromotive swing operation with respect to the swinging member, without the need for power transmission devices such as gears, unlike the case of conventional oscillating mechanisms, thereby enabling accurate, rapid, and efficient driving to be achieved. Even if the swinging position of the swinging member is forcedly changed by an external force, there will be no risk of the breaking of the transmission member.

Preferably, the pan head according to the present invention further includes therein a driving circuit for electrically driving the swinging member to swing and electrically driving the first moving member to slidingly move.

Thereby, the pan head according to the present invention can cause the seat to automatically oscillate in a predetermined direction based on an external electrical command, and can also perform scanning.

It is preferable that the pan head according to the present invention further includes a measuring section for measuring swinging positions of the swinging member and movement positions of the first moving member.

When the pan head is caused to automatically oscillate based on an external electrical command, if the actual oscillation position corresponding to the command is measured and is fed back to an external control circuit, the oscillation position of the pan head could be caused to correspond to the command with higher accuracy.

As an swing position sensor for the swinging member, any one that can measure the rotating direction and rotational amount of a rotating body, such as a potentiometer, rotary encoder, or the like may be used. On the other hand, as a sliding movement position sensor for the first moving member, for example, a. linear potentiometer or electrostatic capacity type position sensor may be employed.

Furthermore, the present invention provides an optical apparatus that includes the pan head according to the present invention, and an optical device, the optical device being mounted on the seat. This optical device is preferably mounted on the seat so that an optical axis to be oscillated or the extension line thereof orthogonally intersects the turning axis of the seat.

In the optical apparatus according to the present invention, the optical device to be used may be any of a light projecting device such as a projector, light-emitting diode, or laser; a light guide device such as a lens, optical fiber, mirror, or half mirror; and a light receiving devices such as a camera or light receiving element. In any case, as an oscillatable optical apparatus, the optical apparatus of the present invention can be significantly reduced in the size and improved in the responsivity compared with conventional optical apparatuses. In particular, when the above-described optical apparatus is installed so that the optical axis thereof or its extension line to be oscillated orthogonally intersects the turning axis of the seat, the oscillation range of the optical axis can assume a sufficiently wide one.

The above and other objects, features, and advantages of the present invention will become clear from the following detailed description of the preferred embodiments of the invention in conjunction with the accompanying drawings.

### BRIEF DESCRIPTION OF THE DRAWINGS

FIG. 1A is a perspective plan view illustrating an embodiment of an optical apparatus according to the present invention, and FIG. 1B is a perspective front view thereof;

FIG. 2 is a block diagram illustrating the construction of a driving circuit in the optical apparatus shown in FIG. 1;

FIG. 3 is a perspective view illustrating an example of a note-book type personal computer equipped with the optical apparatus shown in FIG. 1;

FIG. 4 is a perspective plan view illustrating an operating mode of the optical apparatus shown in FIG. 1;

FIGS. 5A and 5B are perspective plan views each illustrating an operating mode of the optical apparatus shown in FIG. 1;

FIG. 6 is a perspective view collectively illustrating the operating modes of the optical apparatus shown in FIG. 1; and

FIG. 7 is a perspective view illustrating an example of a conventional oscillating mechanism.

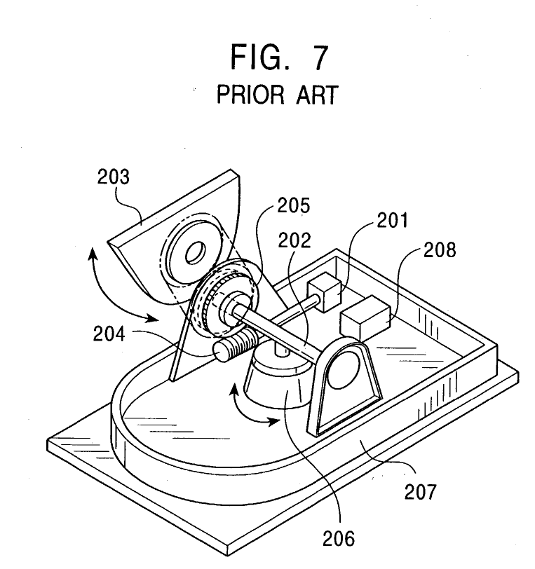

### DESCRIPTION OF THE PREFERRED EMBODIMENTS

Hereinafter the embodiment of the present invention will be described in the form of concrete examples. It is, however, to be understood that these examples do not restrict the present invention. The accompanying drawings are simply for illustrating the thought of the present invention, and elements requiring no explanation are omitted. The shapes of elements and dimensional ratios among them are not necessarily reflect the real ones.

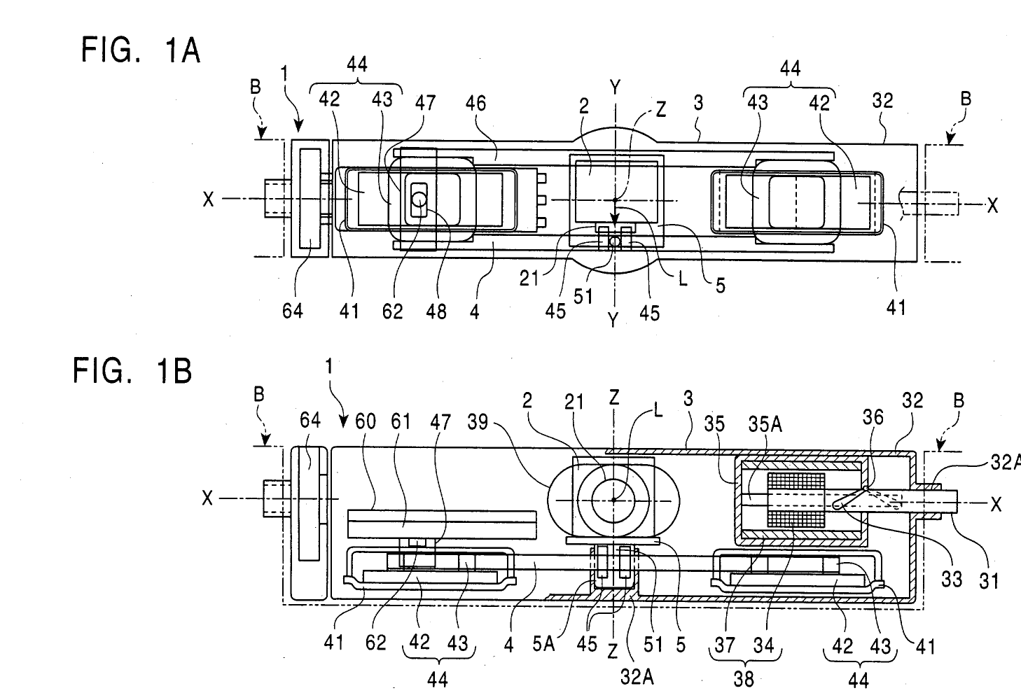

FIG. 1A is a perspective plan view illustrating the embodiment of an optical apparatus according to the present invention, and FIG. 1B is a perspective front view thereof.

In FIGS. 1A and 1B, the optical apparatus according to the present embodiment comprises X, Y, and Z axes that are orthogonally intersect one another. Here, the X-axis is assumed to be placed in the horizontal direction. The optical apparatus of the present embodiment includes a pan head 1, and an optical device 2 mounted on a seat 5 of the pan head 1 and conducting oscillation movements. In this embodiment, the optical device 2 is a CCD (Charge-Coupled Device) camera with a photographing lens 21.

The pan head 1 includes a swinging member 3 capable of swinging about the X-axis as a swing axis; a first moving member 4 mounted on the swinging member 3 and capable of moving parallel with the swing axis X; and a seat 5 capable of turning about the Z-axis, perpendicular to the swing axis X, as a turning axis. The swinging member 3 is constituted of a hollow casing 32 having a substantially elongated rectangular parallelepiped shape and extending to the swing axis X. In this swinging member 3, the aforementioned optical device 2, the first swinging member 3, and the seat 5 are accommodated. The casing 32 has a photographing window 39 to define the field of view of a lens 21 of the optical device (CCD camera) 2.

The seat 5 has a pin-shaped turning member 51 projecting at a position at a distance away from the turning axis Z thereof, and the first moving member 4 has engagement portions 45 that turnably sandwiches therebetween the turning member 51. When the turning member 51 and engagement portions 45 are engaged with each other, the moving motion of the first moving member 4 is directly converted into a turning movement of the seat 5. A pivot 5A is provided at the center on the bottom side of the seat 5, and a bearing portion 32A for supporting this pivot 5A is formed on the inner surface side of the casing 32. The seat 5 is arranged to be capable of turning about the X-axis in a state in which it is supported by the bearing portion 32A. Also, a pair of flange-shaped guide members are attached to the longitudinally central portion of the first moving member 4, and these are disposed so as to sandwich therebetween the turning member 51, thereby constituting the engagement portions 45.

The first moving member 4 extends along the swing axis X in the right-left direction with the engagement portions 45 at the center. On the other hand, across the swing axis X from the first moving member 4 in the casing, there is provided an auxiliary moving member 46 extending parallel with the first moving member 4. The auxiliary moving member 46 and first moving member 4 are coupled by a bridging member 47. At each of the right and left terminals of the first moving member 4, a coil 43 is mounted so as to be sandwiched between the first moving member 4 and auxiliary moving member 46. Also, at each of the right and left terminals of the casing 32, a frame-shaped yoke 41 is provided. While it is not shown in the figures, rail members for guiding the first moving member 4 and auxiliary moving member 46 are formed in the inner wall portion of the. casing 32. By these rail members, the first moving member 4 and auxiliary moving member 46 are supported along the longitudinal direction thereof, and more specifically, they are supported so as to freely move in the direction parallel with the swing axis X. A magnet 42 is mounted on the inner surface of each of the yokes 41, the inner surface being opposed to the coil 43. The two combinations of the magnet 42 and coil 43 each constitutes a set, and forms a VCM 44 for moving the first moving member 4, i.e., a VCM 44 for use in driving the first moving member.

The swinging member 3 has a capsular second moving member 35 installed inside the casing 32 and capable of moving along the swing axis X. On the other hand, in the pan head 1 according to this embodiment, there is provided a tubular fixed shaft 31 extending coaxially with the swing axis X. In this tubular fixed shaft 31, one terminal thereof is fixed to one of support members B (located on the right side in FIGS. 1A and 1B) in a non-rotating state, the support members B sandwiching therebetween the opposite end sides of the swinging member 3 and turnably supporting the swinging member 3. The other terminal of the fixed shaft 31 freely passes through a bearing 32A formed on a side surface of the casing 32 and extends inside the casing 32, and further, freely passes through one side surface (located on the right side in FIGS. 1A and 1B) of the second moving member 35, until it arrives inside the second moving member 35. An insertion member 35A extends from the other side surface (located on the left side in FIG. 1A and 1B) of the second moving member 35 so as to make sliding contact with the inner wall of the tubular fixed shaft 31, whereby the second moving member 35 can move in the casing 32 coaxially with the swing axis X.

A spiral groove 33 extending along the swing axis X is formed on the peripheral surface of the fixed shaft 31 extending within the casing 32. A slider 36 engaged with the spiral groove 33 is provided on the side surface of the second moving member 35 where the side surface the fixed shaft having past through the fixed shaft 31. The slider 36 is arranged to move along the spiral groove 33 when the second moving member moves in the direction of swing axis X. Therefore, by the slider 36 moving along the spiral groove 33, the second moving member 35a is given a rotational force.

A coil 34 is mounted on the terminal of the fixed shaft 31, the terminal extending inside the second moving member 35. On the other hand, a magnet 37 is mounted on the inner wall of the second moving member 35, the inner wall being opposed to the coil 34. The magnet 37 and coil 34 form a VCM 38 for moving the second moving member 35, i.e., a VCM 38 for use in driving the second moving member.

A linear potentiometer 61 for use in position detection is incorporated in the vicinity of one terminal of the casing 32. The linear potentiometer 61 has a probe 62 for use in position measurement that can move in the direction of the swing axis X. On the other hand, the bridging member 47 fixed to the first moving member 4 has an opening 48 formed. The probe 62 is inserted into the opening 48, and as the result of the engagement between the opening 48 and probe 62, the movement position of the first moving member 4 is transmitted to the linear potentiometer 61, whereby it is converted into an electrical signal.

A rotary encoder 64 is mounted on one terminal (left side in FIGS. 1A and 1B) of the casing 32. The rotary encoder 64 detects the swing direction and swing angle of the swinging member 3 to thereby convert them into electrical signals.

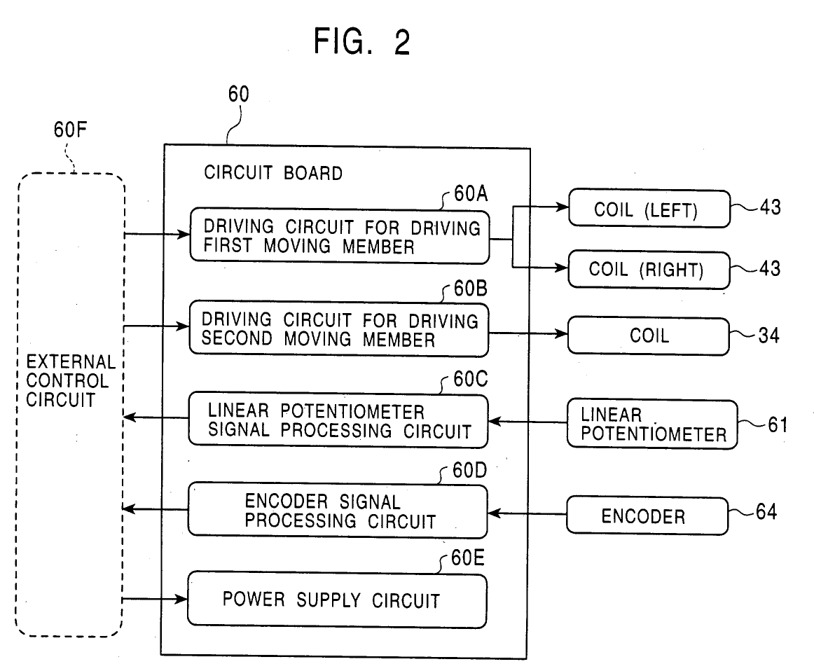

A circuit board 60 is mounted on the back surface of the linear potentiometer 61. FIG. 2 shows an example of a circuit configuration of the circuit board 60.

As shown in FIG. 2, the circuit board 60 includes a circuit 60A for use in driving the first moving member, circuit 60B for use in driving the second moving member, linear potentiometer signal processing circuit 60C, encoder signal processing circuit 60D, and power supply circuit 60E.

In these circuits, by wiring lines (not shown), the circuit 60A for use in driving the first moving member is electrically connected to the right and left coils 43 of the VCM 44 for use in driving the first moving member; the circuit 60B for use in driving the second moving member is connected to the coils 34 of the VCM 38 for use in driving the second moving member; the linear potentiometer signal processing circuit 60C is connected to the linear potentiometer 61; the encoder signal processing circuit 60D is connected to the rotary encoder 64; and the power supply circuit 60E supplies a required power to each of the circuits requiring a power supply. Each of the above-described circuits provided on the circuit board 60 is also connected to an external control circuit 60F and the like by wiring lines (not shown).

In the optical apparatus according to the present embodiment, the optical device 2 is a CCD camera. The CCD camera is installed so that the optical axis (or its extension line) L of the lens 21 of the CCD camera orthogonally intersects the turning axis Z of the seat 5 (in FIG. 1A, the optical axis L coincides with the Y-axis). Wiring lines (not shown) are led out from the CCD camera, and are connected to an external power source and image signal processing circuit.

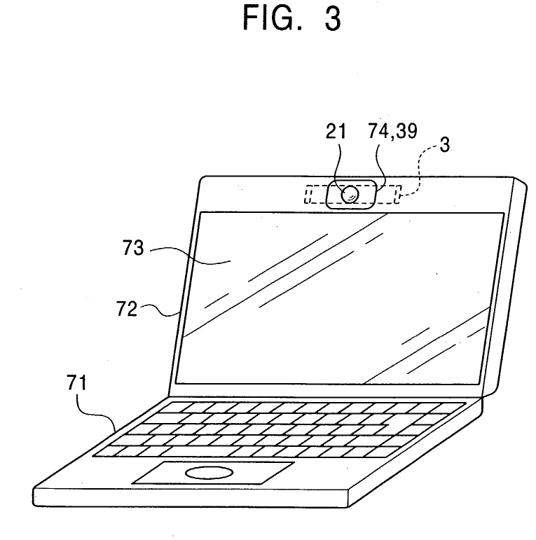

FIG. 3 shows an example of a note-book type personal computer (hereinafter referred to as a “PC”) equipped with the present optical apparatus. In this PC, a keyboard section 71 and a display section 72 is swingably connected by a hinge The display section 72 includes a liquid crystal panel 73 mounted thereon, and a window 74 formed at an upper portion thereof. Inside the window 74, the optical apparatus according to the present embodiment is installed. The support members B supporting the swinging member 3 as shown in FIGS. 1A and 1B, is provided inside the window 74. The present optical apparatus is supported by the support members B in a manner such that the swing axis X is horizontal, and the lens 21 is exposed to the outside through the photographing window 39 in the casing 32 and the window 74 in the housing of the display section 72. While not shown, inside the keyboard section 71, besides a CPU, circuits of the circuit boards 60 and a control circuit for controlling the CCD camera are incorporated.

Next, the operating modes of the present optical apparatus will be described.

(1) Turning of Seat 5

As shown in FIG. 2, firstly a drive command signal for the first moving member is sent from the external control circuit 60F to the first moving member driving circuit 60A. The first moving member driving circuit 60A receives a power supply from the power supply circuit 60E, and after determining the directions and amounts of currents to be delivered to the right and left coils 43 of the VCM 44 for use in driving the first moving member, the first moving member driving circuit 60A delivers the currents to the coils 43. Thereby, each of the coils 43 generates a magnetic field and moves along the respective one of the magnets 42 in a commanded direction (here, it is assumed to be the left direction in FIGS. 1A and 1B) by a commanded distance. Therefore, the first moving member 4, which is connected to the coils 43, moves in the left direction in FIGS. 1A and 1B by the predetermined distance.

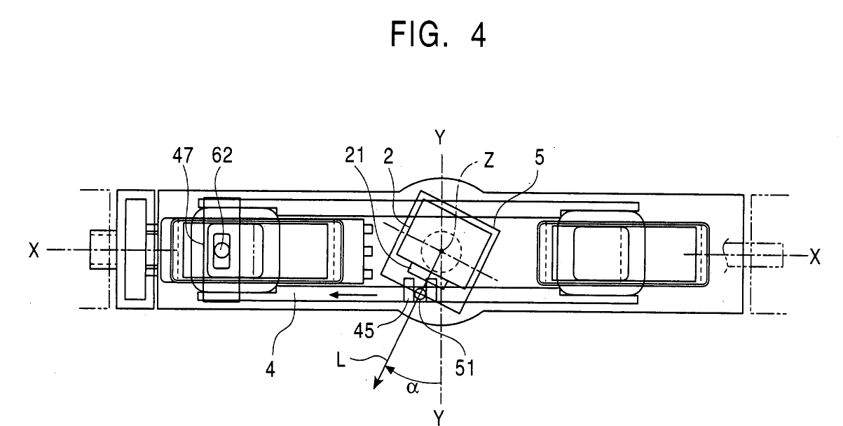

FIG. 4 is a perspective plan view illustrating the first moving member 4 that has moved in the left direction. When the first moving member 4 moves in the left direction, the seat 5 clockwise turns about the turning axis Z since the turning member 51 is engaged with the engaging portions 45 of the first moving member 4. As a result, the optical axis L of the lens 21 of the optical device (CCD camera) 2 turns about the turning axis Z in the left direction by an angle of α. If the direction of a current to be delivered to the coils 43 is reversed, the first moving member 4 will move in the right direction, and the optical axis L of the lens 21 will turn in the right direction.

As described above, the probe 62 of the linear potentiometer 61 is engaged with the opening 48 of the bridging member 47 connected to the first moving member 4. Therefore, when the first moving member 4 moves at the drive command, the linear potentiometer 61 detects the movement direction and moving amount of the first moving member 4 by the movement of the probe 62, and sends this information to the external control circuit 60 F via the linear potentiometer signal processing circuit 60C. The external control circuit 60F feeds back this information to the first moving member driving circuit 60A, thereby more accurately controlling the current amount to be delivered to the coils 43. Ps (2) Swing of Swinging Member 3

A driving command for the second moving member 35 is sent from the external control circuit 60F to the second moving member driving circuit 60B. The second moving member driving circuit 60B receives a power supply from the power supply circuit 60E, and after determining the direction and amount of a current to be delivered to the coil 34 of the VCM 38 for use in driving the second moving member, the second moving member driving circuit 60B delivers the current to the coil 34. Thereby, the coil 34 generate a magnetic field and moves along the magnet 37 in a commanded direction (here, it is assumed to be the right direction in FIGS. 1A and 1B) by a commanded distance. Therefore, the second moving member 35, which is connected to the coil 34, moves in the right direction by the predetermined distance. Herein, since the slider 36 provided on the second moving member 35 is in engagement with the spiral groove 33 formed on the peripheral surface of the fixed shaft 31, the slider 36 moves in the right direction along the spiral groove 33, thereby turning the second moving member 35.

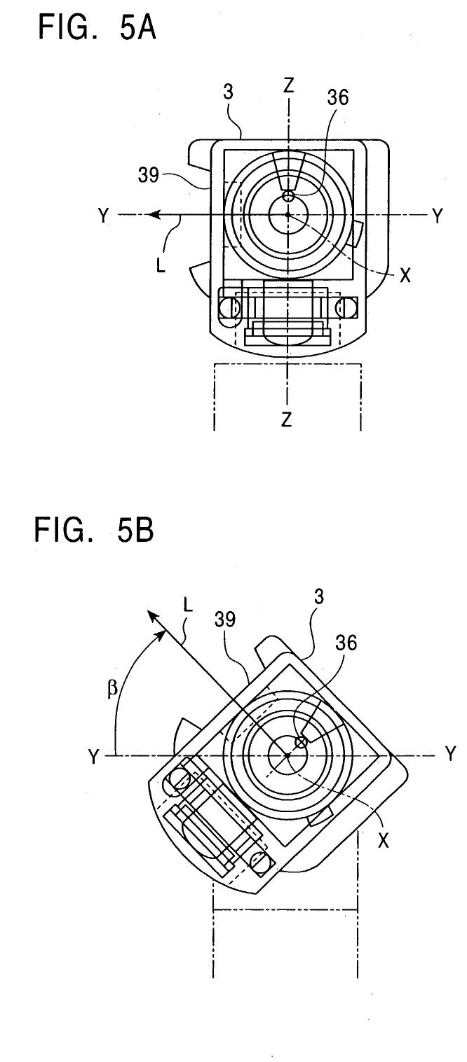

FIG. 5A is a perspective plan view showing a swinging member 3 before the slider 36 starts to move, while FIG. 5B is a perspective plan view showing a swinging member 3 after the slider 36 has moved. When the slider 36 moves, the fixed shaft 31 does not turn, and also the second moving member 35 does not turn with respect to the casing 32 of the swinging member 3, and therefore, as shown in FIG. 5B, a rightward movement of the slider 36 is converted into an upward turning of the swinging member 3. Therefore, the optical axis L of the lens 21 of the optical device (CCD camera) 2, which has initially lain on the Y-axis in a horizontal plane as shown in FIG. 5A, turns about the swing axis X in the upward direction by an angle of β, as shown in FIG. 5B. If the direction of current to be delivered to the coils 34 is reversed, the slider 36 will move in the left direction, and the optical axis L of the lens 21 will turn in the downward direction.

When the swinging member 3 turns at the drive command, the rotary encoder 64 detects the turning direction and turning amount of the swinging member 3, and sends this information to the external control circuit 60F via the encoder signal processing circuit 60D. The external control circuit 60F feeds back this information to the second moving member driving circuit 60B, thereby more accurately controlling the current amount to be delivered to the coil 34.

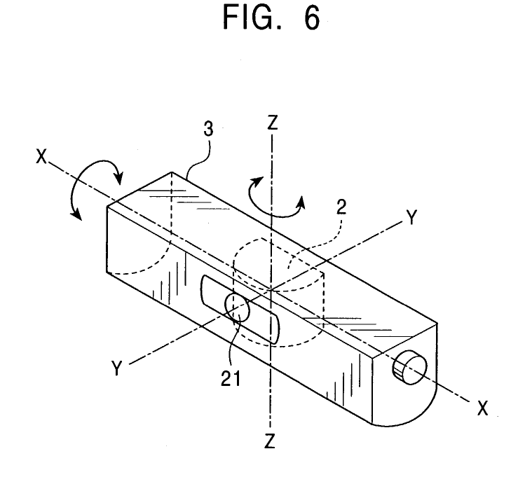

FIG. 6 is a perspective view collectively illustrating the above-described operating modes of the present optical apparatus As shown in FIG. 6, in the present optical apparatus, the optical axis of the lens 21 turns about the turning axis Z by the movement of the first moving member 4 along the swing axis X, and the optical axis of the lens 21 turns about the swing axis x by a movement of the second moving member 35 along the swing axis X. Therefore, by combining the movement of the first moving member and that of the second moving member, it is possible to swing the optical axis L in any of the right, left, up, and down directions, and to perform scanning or panning in a predetermined pattern.

With a CCD camera mounted on the compact and electronically controllable pan head, the optical apparatus of the present embodiment can be easily installed on a compact information device such as the above-described notebook type personal computer PC or mobile telephone without failing to meet the request for miniaturization, and enables the photographing field to be directed in any of the right, left, up, and down directions by an remote command from the keyboard or the like, or allows scanning.

In this embodiment, although a CCD camera is mounted as the optical device 2, other optical devices may be used to achieve similar effects of oscillations in the right, left, up, and down directions. For example, if the pan head 1 of the present embodiment is mounted on the front end of a fiberscope, and an illuminating light and/or camera is installed on the seat 5, a small-diameter fiberscope that can be remotely controlled by electromotion could be achieved. Also, if a laser is mounted on the seat 5, a compact laser emitter allowing a high-speed scanning could be attained. Furthermore, if some lenses of a photographing lens system is mounted on the seat 5, photographing lenses having a shake-preventing mechanism could be implemented. Moreover, if the pan head 1 of the present embodiment is incorporated into an optical device comprising an optical fiber, mirror, and half mirror and the like, a multi-contact optical switch could be formed on light guiding paths in an optical system. Besides, the pan head of the present embodiment may be incorporated into various compact devices, toys and the like other than optical apparatuses, in order to oscillate predetermined members thereof.

As described above, the pan head according to the present invention includes the swinging member capable of swinging about the swing axis, the first moving member mounted on the swinging member and capable of moving along the swing axis, and the seat capable of turning about the axis perpendicular to the swing axis, as a turning axis, wherein the moving motion of the first moving member is converted into a turning movement of the seat. This facilitates the miniaturization and electronic control of the present pan head. By arranging the swinging member to swing by the movement of the second moving member along the swing axis, an object mounted on the seat can be directed in any of the right, left, up, and down directions only by the movements of the first and second moving members along the swing axis. Moreover, by performing the movements of the first and second moving members by means of VCMs, a pan head having a more compact and electronically controllable oscillating mechanism, and an optical apparatus using the same can be realized.

While the present invention has been described with reference to what are at present considered to be the preferred embodiments, it is to be understood that various changes and modifications may be made thereto without departing from the present invention in its broader aspects and therefore, it is intended that the appended claims cover all such changes and modifications that fall within the true spirit and scope of the invention.

ATTACHMENT A

| | |
|---|---|
| Guy W Shoup | 26,805 |
| F. David AuBuchon | 20,493 |
| Gustavo Siller, Jr. | 32,305 |
| Jasper W. Dockrey | 33,868 |
| John C. Freeman | 34,483 |
| William F. Prendergast | 34,699 |
| Michael E. Milz | 34,880 |
| Tadashi Horie | 40,437 |
| Richard K. Clark | 40,560 |
| Joseph F. Hetz | 41,070 |
| Jason C. White | 42,223 |
| James A. Collins | 43,557 |
| Anthony P. Curtis | 46,193 |

What is claimed is:

1. A pan head, comprising:
a swinging member capable of swinging about one axis as a swing axis;
a first moving member supported by said swinging member, and capable of slidingly moving along said swing axis; and
a seat capable of turning about an axis perpendicular to said swing axis, as a turning axis,
wherein the sliding movement of said first moving member is converted into a turning movement of said seat.

2. The pan head according to claim 1, wherein said seat has a turning member at a position a distance away from the turning axis, wherein said first moving member has engagement portions where said first moving member is engaged with said turning member, and wherein the sliding movement of said first moving member is converted into a turning movement of said seat by the engagement between said turning member and engagement portions.

3. The pan head according to claim 1, wherein said first moving member slidingly moves by being driven by voice coil motors each comprising a magnet mounted on either one of said first moving member and swinging member, and a coil mounted on the other.

4. The pan head according to claim 1, wherein said swinging member has a second moving member mounted on said swinging member, and capable of slidingly moving along said swing axis, and wherein the sliding movement of said second moving member is converted into a swinging movement of said swinging member.

5. The pan head according to claim 4, further comprising:
a non-rotating fixed shaft extending coaxially with said swing axis, wherein said second moving member is opposed to the peripheral surface of said fixed shaft;
a spiral groove extending along said swing axis, said spiral groove being formed on either one of the peripheral surface of said fixed shaft and said second moving member; and
a slider sliding in engagement with said spiral groove, said slider being disposed on the other of the above-described peripheral surface of said fixed shaft and said second moving member,
wherein, when said second moving member moves along said swing axis, said slider moves along said spiral groove, and thereby the sliding movement of said second moving member is converted into a swinging movement of said swinging member.

6. The pan head according to claim 5, wherein said second moving member slidingly moves by being driven by a voice coil motor comprising a magnet mounted on either one of the peripheral surface of said fixed shaft and said second moving member, and a coil mounted on the other.

7. The pan head according to claim 1, further comprising therein a driving circuit for electrically driving the swinging member to swing and electrically driving said first moving member to slidingly move.

8. The pan head according to claim 1, further comprising a measuring section for measuring swinging positions of said swinging member and movement positions of said first moving member.

9. An optical apparatus comprising the pan head according to claim 1, and an optical device, said optical device being mounted on said seat.

10. The optical apparatus according to claim 9, wherein said.optical device is mounted on said seat so that an optical axis to be oscillated or the extension line thereof orthogonally intersects the turning axis of said seat.
